(19) United States
(12) Patent Application Publication
(10) Pub. No.: US 2004/0010538 A1
(43) Pub. Date: Jan. 15, 2004

(54) Apparatus and method for determining valid data during a merge in a computer cluster

(75) Inventors: Robert Miller, Rochester, MN (US); Laurie Ann Williams, Rochester, MN (US); Ben-Ami Yassour, Haifa (IL)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/193,541

(22) Filed: Jul. 11, 2002

(51) Int. Cl. G06F 15/16

(52) U.S. Cl. 709/201; 709/205

(57) ABSTRACT

A logical clock is provided that is incremented each time there is a membership change in a cluster of computer systems. The value of the logical clock is written as part of each data record created or modified by the cluster on behalf of a user. When a partition occurs, and a merge then follows the partition, a partition merge processing mechanism transmits a node list and data record headers (i.e., data records without their associated data) from a computer that was in the first partition to the computers that were in the second partition, and transmits a node list and data record headers from a computer that was in the second partition to the computers that were in the first partition. The partition merge processing mechanism then determines from the values of the logical clock in the data record headers and in the local data records where the most recent data resides. If data was updated in only one partition during the partition, the data is copied to the computers that were in the other partition. If data was updated in both partitions, the partition merge processing mechanism marks the conflicting data records. An application that sees conflicting data records can then take appropriate action, such as aborting or resetting the transactions that caused the independent updates. The preferred embodiments efficiently determine where valid data resides during a merge in a computer cluster, making it possible to avoid the costly overhead of maintaining and processing history logs.

### BACKGROUND OF THE INVENTION

1. Technical Field

This invention generally relates to data processing, and more specifically relates to the sharing of tasks between computers on a network.

2. Background Art

Since the dawn of the computer age, computer systems have become indispensable in many fields of human endeavor including engineering design, machine and process control, and information storage and access. In the early days of computers, companies such as banks, industry, and the government would purchase a single computer which satisfied their needs, but by the early 1950's many companies had multiple computers and the need to move data from one computer to another became apparent. At this time computer networks began being developed to allow computers to work together.

Networked computers are capable of performing tasks that no single computer could perform. In addition, networks allow low cost personal computer systems to connect to larger systems to perform tasks that such low cost systems could not perform alone. Most companies in the United States today have one or more computer networks. The topology and size of the networks may vary according to the computer systems being networked and the design of the system administrator. It is very common, in fact, for companies to have multiple computer networks. Many large companies have a sophisticated blend of local area networks (LANs) and wide area networks (WANs) that effectively connect most computers in the company to each other.

With multiple computers hooked together on a network, it soon became apparent that networked computers could be used to complete tasks by delegating different portions of the task to different computers on the network, which can then process their respective portions in parallel. In one specific configuration for shared computing on a network, the concept of a computer “cluster” has been used to define groups of computer systems on the network that can work in parallel on different portions of a task.

Ordered messages may be used in a computer cluster to communicate information to all computers (or nodes) in the cluster. A communication mechanism in the cluster assures that all messages are seen by all nodes in the same order. Thus, a user can store data on one cluster node, and that data will be replicated to all nodes in the cluster via ordered messages. However, sometimes a network failure will cause a cluster to be partitioned, which means that one or more nodes can no longer communicate with other nodes in the cluster. While the cluster is partitioned, it is possible that nodes in the separate partitions change their respective records that represent the same data. For this reason, it necessary to determine where the most recent data resides when the two partitions are merging into a single cluster again. In the prior art, history logs are kept for each data record. During the merge, the history logs are processed to determine where the most recent data resides. Note, however, that the process of creating and processing history logs is time-consuming and takes substantial system overhead and memory resources. Without a mechanism to more easily and quickly determine the location of data when partitions are merged, the performance of clusters will continue to be impaired by the necessity to maintain and process history logs.

### DISCLOSURE OF INVENTION

According to the preferred embodiments, a logical clock is provided that is incremented each time there is a membership change in a cluster of computer systems. The value of the logical clock is written as part of each data record created or modified by the cluster on behalf of a user. When a partition occurs, and a merge then follows the partition, a partition merge processing mechanism transmits a node list and data record headers (i.e., data records without their associated data) from a computer that was in the first partition to the computers that were in the second partition, and transmits a node list and data record headers from a computer that was in the second partition to the computers that were in the first partition. The partition merge processing mechanism then determines from the values of the logical clock in the data record headers and in the local data records where the most recent data resides. If data was updated in only one partition during the partition, the data is copied to the computers that were in the other partition. If data was updated in both partitions, the partition merge processing mechanism marks the conflicting data records. An application that sees conflicting data records can then take appropriate action, such as aborting or resetting the transactions that caused the independent updates. The preferred embodiments efficiently determine where valid data resides during a merge in a computer cluster, making it possible to avoid the costly overhead of maintaining and processing history logs.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of computer systems that may intercommunicate on a network, with a dashed line that shows how nodes in a cluster may become partitioned;

FIG. 3 is a block diagram of a prior art cluster node;

FIG. 4 is a block diagram of a prior art data record that is sent between nodes in a prior art cluster;

FIG. 5 is a block diagram of an entry in a prior art history log that records data transactions in a prior art computer cluster;

FIG. 6 is a block diagram of a prior art node list that is maintained on each node in a prior art computer cluster;

FIG. 7 is a flow diagram of a prior art method for determining valid data when a prior art cluster partitions, then merges;

FIG. 8 is a block diagram of a cluster node in accordance with the preferred embodiments;

FIG. 9 is a block diagram of a data record in accordance with the preferred embodiments;

FIG. 10 is a node list that is maintained on each node in accordance with the preferred embodiments;

FIG. 11 is a flow diagram of a method in accordance with the preferred embodiments for determining valid data when a prior art cluster partitions, then merges;

FIG. 12 is a block diagram showing how node B's node list and data record headers (i.e., data records without data) are sent to node A during a merge; and

FIGS. 13-15 are parts of a flow diagram of one specific implementation in accordance with the preferred embodiments for determining valid data during a merge.

### BEST MODE FOR CARRYING OUT THE INVENTION

The present invention is accomplished through sharing portions of tasks on computers that are connected on a network. For those who are not familiar with networking concepts, the brief overview below provides background information that will help the reader to understand the present invention.

1. Overview

### Networked Computer Systems

Connecting computers together on a network requires some form of networking software. Over the years, the power and sophistication of networking software has greatly increased. Networking software typically defines a protocol for exchanging information between computers on a network. Many different network protocols are known in the art. Examples of commercially-available networking software is Novell Netware and Windows NT, which each implement different protocols for exchanging information between computers. Netware is a trademark of Novell, Inc. and Windows NT is a trademark of Microsoft Corporation.

One significant computer network that has recently become very popular is the Internet. The Internet grew out of a proliferation of computers and networks, and has evolved into a sophisticated worldwide network of computer systems. Using the Internet, a user may access computers all over the world from a single workstation. TCP/IP (Transmission Control Protocol/Internet Protocol) is an example of a network protocol that is in wide use today for communicating between computers on the Internet. In addition, the use of TCP/IP is also rapidly expanding to more local area networks (LANs) and Intranets within companies.

### Computer Clusters

The prior art recognized the benefit of having groups of computer systems work on different pieces of a problem. The concept of “clusters” of computers evolved to include a predefined group of networked computers that can share portions of a larger task. One specific implementation of a cluster uses ordered messages for communicating between the computers in a cluster. In an ordered message system, each message is communicated to all nodes, and the order of messages is enforced so that all nodes see the messages in the same order.

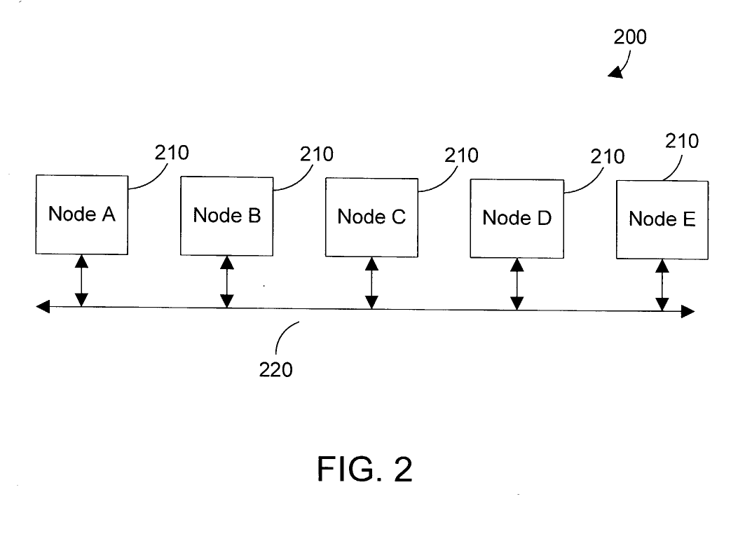

Referring to FIG. 2, a simple cluster 200 of five computer systems (or “nodes”) 210 is shown. The connections between these nodes represent a logical connection, and the physical connections can vary within the scope of the preferred embodiments so long as the nodes in the cluster can logically communicate with each other. Within a cluster, one or more “groups” may be defined, which correspond to logical groupings of nodes that cooperate to accomplish some task. Each node in a group is said to be a “member” of that group.

FIG. 2 includes dashed lines 220 that represents how nodes in a cluster may be partitioned. In FIG. 2, we assume that nodes A and B are temporarily partitioned from nodes C, D and E. As long as the separation between partitions represented by line 220 exists, it is possible that nodes in both partitions update the same data record. Once the two partitions merge back together, the data in the two partitions must be reconciled to determine which is more recent, and to determine whether both partitions updated the same data while partitioned. If both partitions updated the same data, the data is marked as conflicting, which indicates invalid data.

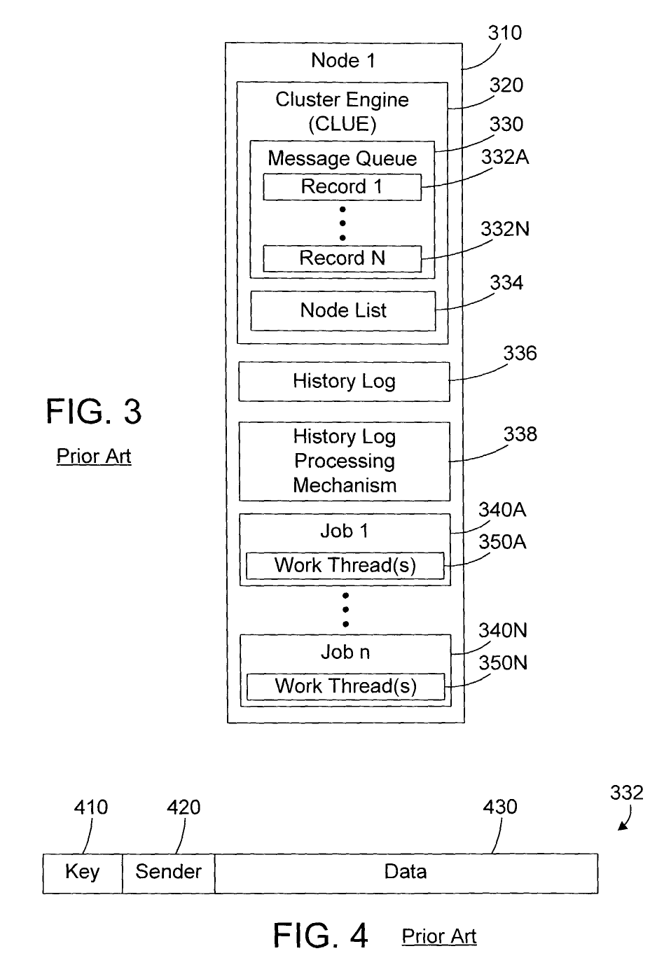

As shown in FIG. 3, each node 310 in a prior art cluster includes a cluster engine 320 (referred to herein as CLUE), a history log 336, a history log processing mechanism 338, and one or more jobs 340, represented in FIG. 3 as job 340A and 340N. Each job 340 includes one or more work threads 350 that execute the job 340, which amounts to a portion of the larger task that is being delegated to the members of the group.

CLUE 320 is a software process that enforces ordered messages between nodes in a cluster. All messages by any member of the group are communicated to the node's local CLUE 320, which then communicates the message to all other members of the group. When a job 340 wants to be part of a group, it registers with CLUE 320 as a member of that group. This registration causes CLUE to generate a membership change message to other members of the group to inform the other members of the new addition to the group. In similar fashion, when a job 340 no longer wants to be a member of the group, it unregisters with CLUE 320, which also causes a corresponding membership change message to inform the remaining members of the group that a member has been deleted from the group. When CLUE 320 receives a message from its member that is intended for the group, CLUE 320 sends the message to all registered members.

CLUE 320 includes a message queue 330 that contains records 332 (shown by 332A and 332N in FIG. 3). CLUE 320 also includes a node list 336 that is a list of all nodes currently in the cluster. Node list 336 is changed as member nodes are added or deleted using membership change messages.

A history log 224 is used to record all changes to data processed off the message queue 330. A history log 224 for a cluster is analogous to a journal in a database that records changes to data records in the database. A history log processing mechanism 338 is provided that processes history log 334 in the event of a partition, followed by a merge. In this case, it is not readily evident whether data on one partition was changed, or whether data on two separate partitions were changed. History log processing mechanism 338 can thus determine where the most recent data resides, and what actions to take based on where the data resides. Note, however, that keeping and processing the history log 334 uses significant system resources, and creates considerable system overhead.

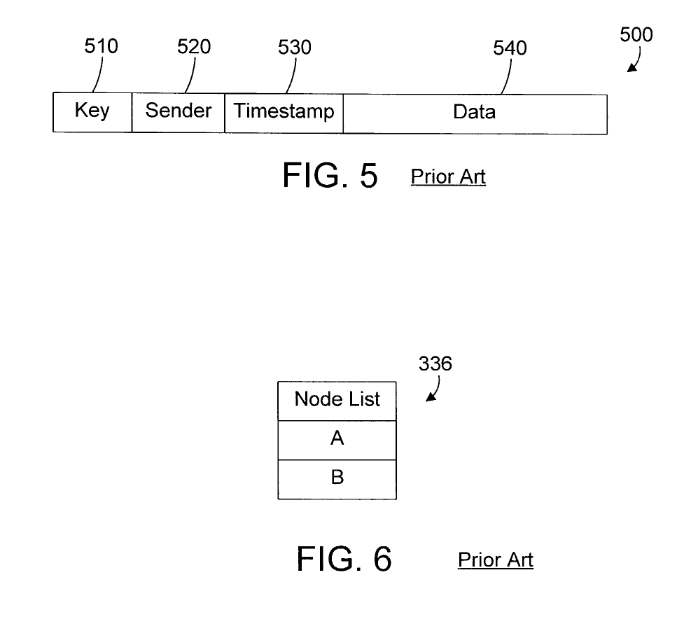

FIG. 4 shows a prior art data record 332 that is used in prior art computer clusters. Record 332 includes a key 410, an indication of which node sent the message 420, and a data field 430. The key 410 is a unique identifier for the record 332. FIG. 5 shows a prior art entry 500 to a history log, such as history log 334 in FIG. 3. Entry 500 includes a key 510, sender 520, and data 540, similar to the record 332 in FIG. 4. Note, however, that the history log entry additionally contains a timestamp 530. This timestamp 530 is a timestamp that is generated from a time source that is synchronized across nodes in a cluster to assure that the time index of partitioned nodes is relative. History log processing mechanism 338 in FIG. 3 uses the timestamp 530 of entries in the history log to determine which node contains valid data when a merge occurs in a cluster following a partition. FIG. 6 is a prior art node list 336 that lists nodes that are currently in the cluster. For the example of FIG. 6, nodes A and B are current members of the cluster.

The problem of providing a synchronized time source in a computer cluster that is available to nodes even during a partition has not been addressed by industry. No widely accepted standard exists for synchronizing multiple masters. Some implementations allow an administrator to explicitly identify one master that is used to synchronize all others. Another implementation allows updates to only be performed on one master, which then replicates the update to the other masters. All of these prior art implementations suffer from considerable drawbacks.

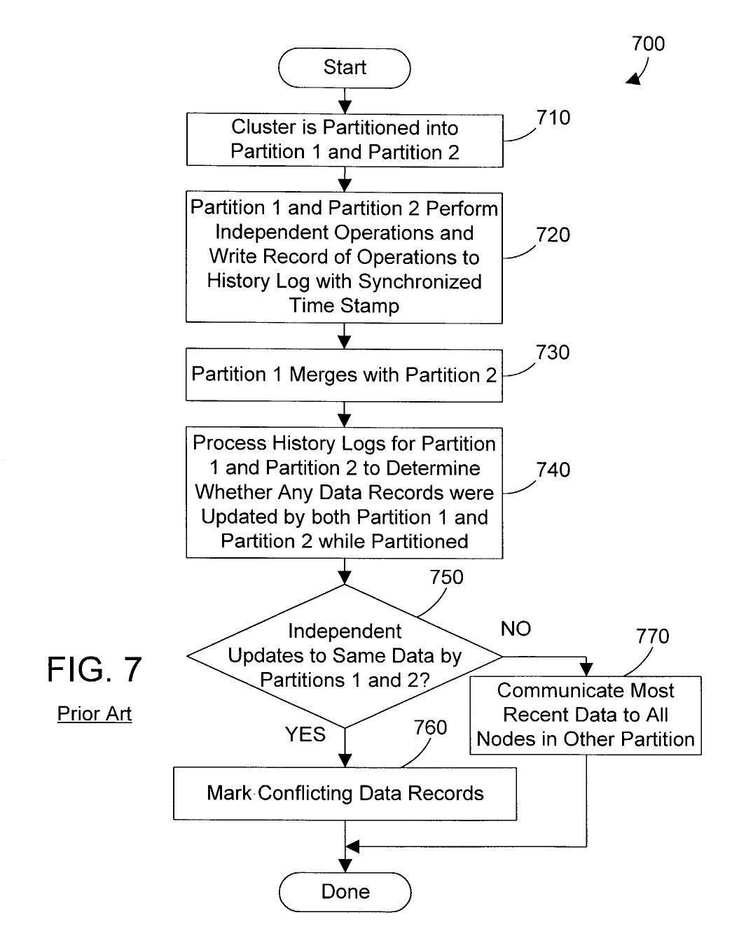

A prior art method 700 for determining valid data during a merge in a cluster is shown in FIG. 7. We assume that a cluster is partitioned into two distinct partitions, Partition 1 and Partition 2 (step 710). The number of nodes in each partition is irrelevant, so long as at least one node is in each partition. We assume that after the partition in step 710, that Partition 1 and Partition 2 perform independent operations and write a record of their operations to their history logs with the synchronized time stamp 530 shown in FIG. 5. We now assume that Partition 1 merges with Partition 2 (step 730). As a result of the merge, data records between nodes that were in the different partitions may be inconsistent. As a result, the history log processing mechanism processes the history logs for Partition 1 and Partition 2 to determine whether any data records were updated by both partitions (step 740). If there were independent updates to the same data by both partitions (step 750=YES), the conflicting data records are marked (step 760). An application using the data record may then take appropriate action when it discovers the data record is marked as conflicting with another data record. If there were no independent updates to the same data by both partitions (step 750=NO), any data that was updated on only one of the partitions is communicated to all other nodes (step 770).

A problem with the prior art as shown in simplified form in FIGS. 3-7 is that keeping a history log is very expensive in terms of processing overhead and memory resources. In addition, processing the history log is a time-consuming process. Given the fact that partitions are common occurrences on wide area networks (WANs), the overhead in determining valid data during a merge has become a significant factor that negatively affects system performance. What is needed is a way to more easily determine valid data during a merge without using history logs. The preferred embodiments described below provide just such a solution.

2. Detailed Description

According to a preferred embodiment of the present invention, an apparatus and method allow easily determining valid data during a merge in a computer cluster without having to keep and process history logs. A logical clock is incremented each time a membership change to the cluster occurs. The value of the logical clock is stored with each data record when the record is created or modified. In this manner, the value of the logical clock in a data record indicates whether the data in the data record is more recent, less recent, or the same as data stored in a data record on a different node that was temporarily in a different partition. By storing the logical clock value with the data record, the most recent data may be easily identified without the overhead of keeping and processing history logs, and without the burden of providing a synchronized real-time clock.

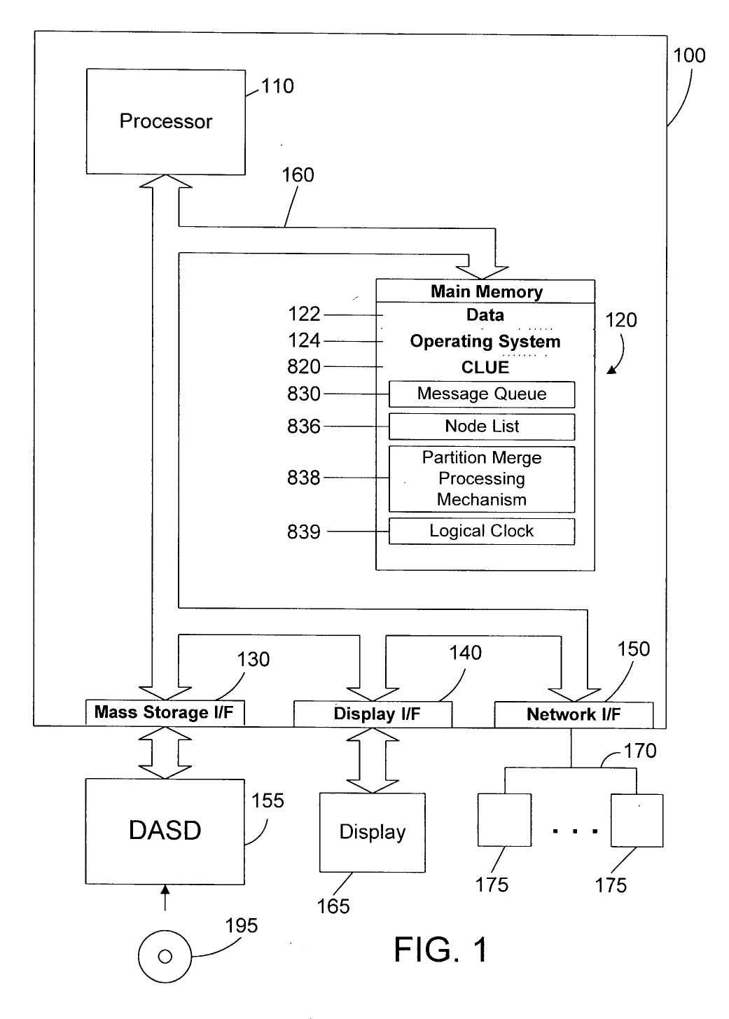

Referring now to FIG. 1, a computer system 100 is an enhanced IBM iSeries computer system, and represents one suitable type of node 210 (FIG. 2) that can be networked together in accordance with the preferred embodiments. Those skilled in the art will appreciate that the mechanisms and apparatus of the present invention apply equally to any computer system that can be networked together with other computer systems. As shown in FIG. 1, computer system 100 comprises a processor 110 connected to a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a CD ROM drive, which may store data to and read data from a CD ROM 195.

Main memory 120 contains data 122, an operating system 124, and a cluster engine (CLUE) 820. Cluster engine 820 preferably includes a message queue 830, a node list 836, a partition merge processing mechanism 838, and a logical clock 839. Data 122 represents any data that serves as input to or output from any program in computer system 100. Operating system 124 is a multitasking operating system known in the industry as OS/400; however, those skilled in the art will appreciate that the spirit and scope of the present invention is not limited to any one operating system. CLUE 230 is a cluster engine that communicates with other computer systems in a defined cluster. In the preferred embodiments, CLUE 230 enforces ordered messages, which means that each member in the cluster will see messages in the same order. Message queue 830 is a queue where all messages from other nodes in the cluster are stored. Node list 836 is a list of nodes that are in the current cluster including nodes that are partitioned. Partition merge processing mechanism 838 detects when a partition occurs followed by a merge, and as part of processing the merge, the partition merge processing mechanism 838 determines which data in the cluster is valid (i.e., the most recent). Mechanism 838 can also determine if the same data was updated in different partitions, resulting in a conflict in the data. Logical clock 839 is a counter that is used as a type of relative time stamp. The value of the logical clock 839 is preferably initialized to zero. Each time a membership change occurs in the cluster, the logical clock 839 is incremented. The value of the logical clock 839 is written to a data record when the data in the record is created or updated. In this manner each data record has a logical clock value that may be compared to the logical clock values of other data records to determine which data records among nodes are the most recent.

One of the significant advantages of the preferred embodiments over the prior art is that no synchronized real-time clock has to be available to all members of the cluster, even when partitioned. In the prior art, the timestamp 530 (FIG. 5) in the history log had to be a timestamp from a synchronized real-time clock. For the preferred embodiments, the logical clock contains a count of cluster events, and is used as a relative index between records to determine which record is more recent.

Another significant advantage of the preferred embodiments is that history logs are no longer needed. Eliminating history logs eliminates substantial processing and memory overhead from a computer cluster.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 122, operating system 124, and CLUE 820 are shown to reside in main memory 120, those skilled in the art will recognize that these items are not necessarily all completely contained in main memory 120 at the same time. It should also be noted that the term “memory” is used herein to generically refer to the entire virtual memory of computer system 100.

In FIG. 1, the message queue 830, node list 836, partition merge processing mechanism 838, and logical clock 839 are shown as part of CLUE 820. Note, however, that it is equally within the scope of the preferred embodiments to provide any of these items external to CLUE 820.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 124. Operating system 124 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) displays or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. Network 170 represents the logical connections between computer system 100 and other computer systems on the network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROM (e.g., 195 of FIG. 1), and transmission type media such as digital and analog communications links.

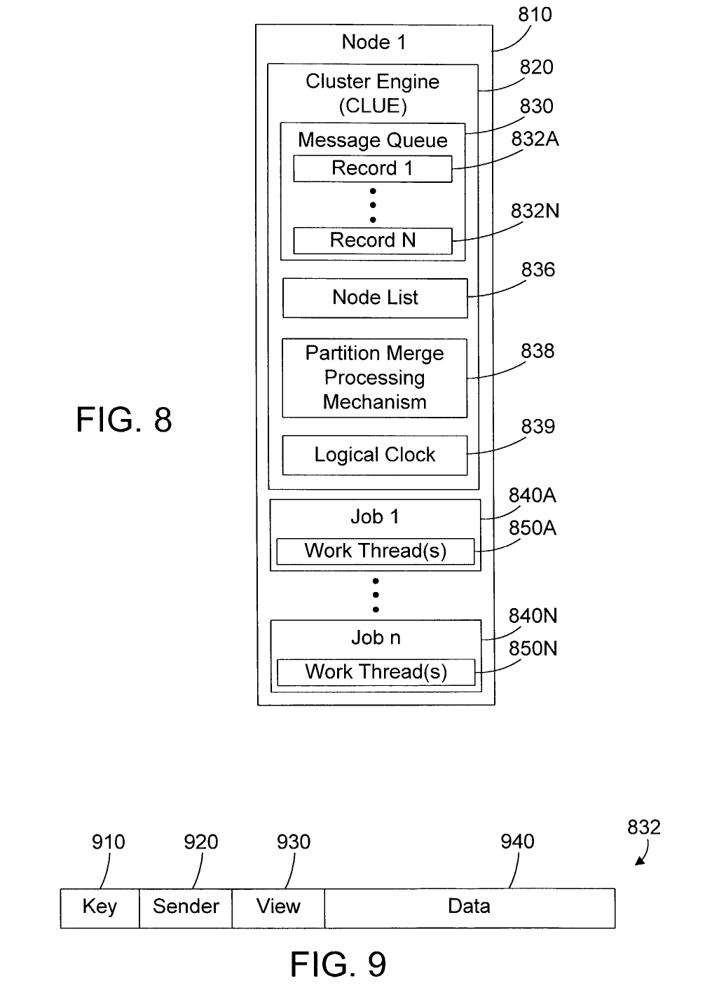

Referring now to FIG. 8, a node 810 represents a node in a cluster, such as nodes 210 shown in FIG. 2. Note that many of the features shown in FIG. 8 were discussed above with reference to FIG. 1. Node 810 in accordance with the preferred embodiments includes a cluster engine (CLUE) 820, and one or more jobs 840. Each job 840 has one or more corresponding work threads 850 that perform a task delegated to node 810. CLUE 820 preferably includes a message queue 830 that contains one or more records 832, shown in FIG. 8 as 832A and 832N. A node list 836 includes all of the nodes in the current cluster. The partition merge processing mechanism 838 processes records 832 during a merge to determine which records are the most recent. Logical clock 839 provides a time index whose value depends on the number of membership changes to the cluster.

FIG. 9 illustrates a sample data record 832 in accordance with the preferred embodiments. Data record 832 includes a key 910, an indication of which node created or updated the record 920, a view field 930, and data 940. Note that a difference between the record 832 shown in FIG. 9 and the prior art record 332 of FIG. 4 is the presence of the view field 930. The view field 930 preferably contains the value of the logical clock at the time the data record 832 is created or changed. As noted above, the logical clock preferably starts at zero, and is incremented by one for each membership change in the cluster. By including the view field 930, each data record 832 includes its own relative time stamp based on cluster membership changes. Because partitions and merges both result in membership changes to a cluster, comparing the view field of a data record with a view field of the same data record on a different node will quickly indicate which record, if any, is the most recent and which contains valid data. Because the key, sender, and data are present in the prior art implementation, the only additional overhead for the preferred embodiments is the number of bytes used for the view field.

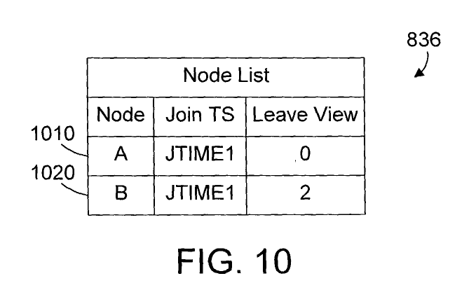

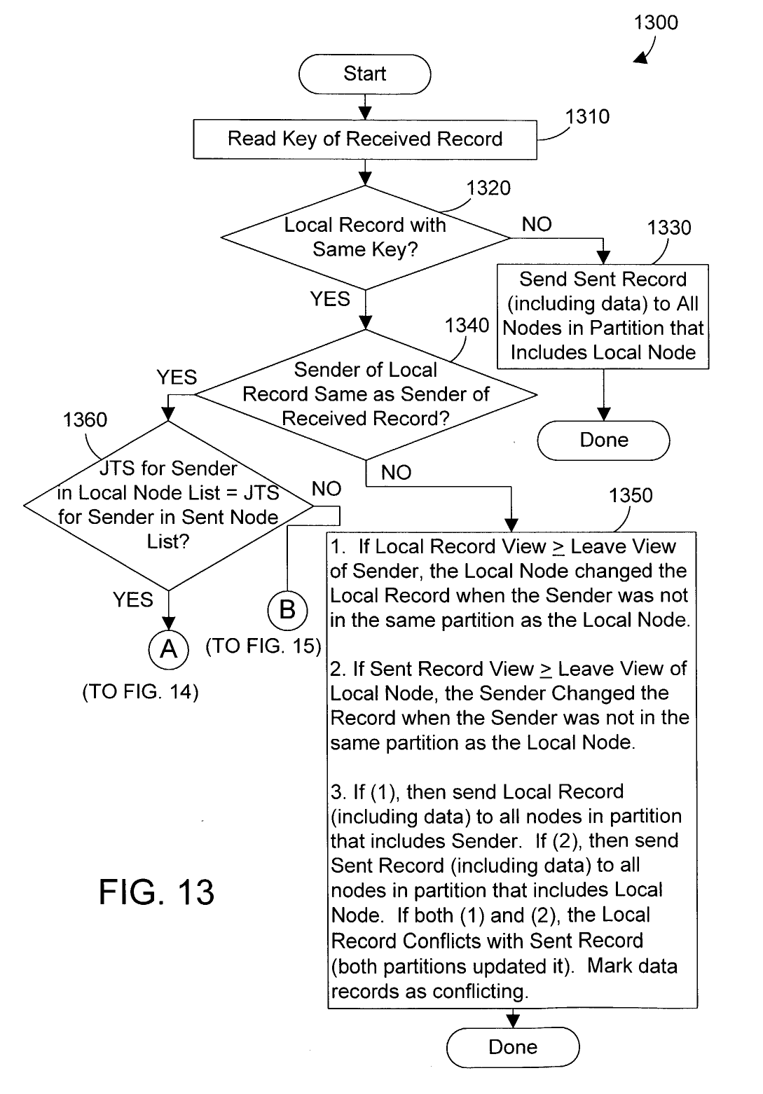

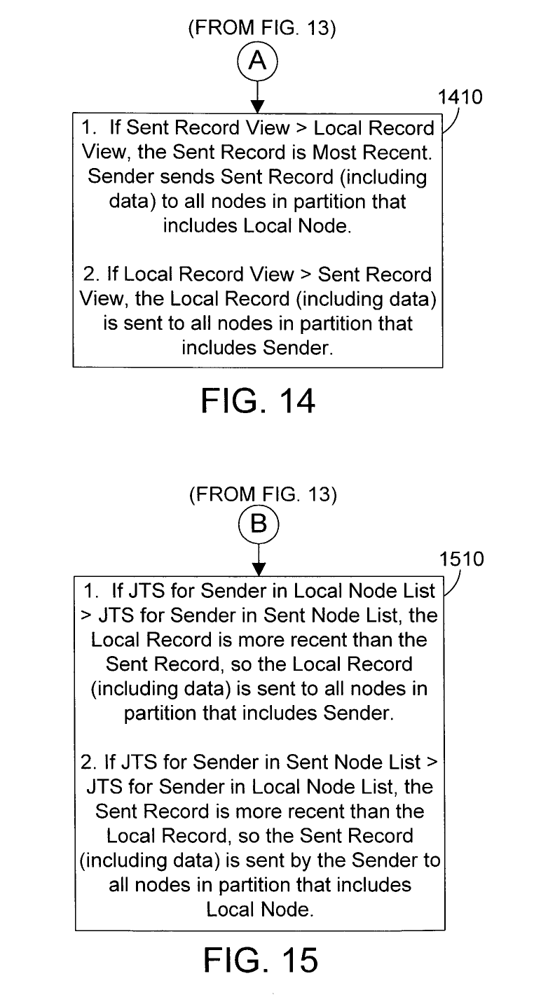

Referring now to FIG. 10, a node list 836 in accordance with the preferred embodiments includes one or more entries that each correspond to a node that is currently in the cluster. Entries 1010 and 1020 are shown in FIG. 10 by way of example. Each entry lists the node, a timestamp (Join TS) of when the node joined the cluster, and a leave view. The use of the join timestamp is described below in more detail in the discussion regarding FIGS. 13-15. The leave view field contains the value of the logical clock when the cluster last left the cluster. If the node has never left the cluster, then the value in the leave view field is zero.

The node list 836 preferably gets updated when a membership change is detected in the cluster, preferably a result of CLUE 820 receiving a membership change message. Because each node in the cluster gets the membership change notice, each node knows which nodes are joining or leaving. Each membership change message has the same view, so it is a simple matter for each node to record the leave view for leaving nodes. For a joining node, the joiner broadcasts to all nodes its timestamp when it received the membership change message indicating that it joined the cluster. This timestamp is recorded by each node as the join timestamp (Join TS) for the joiner.

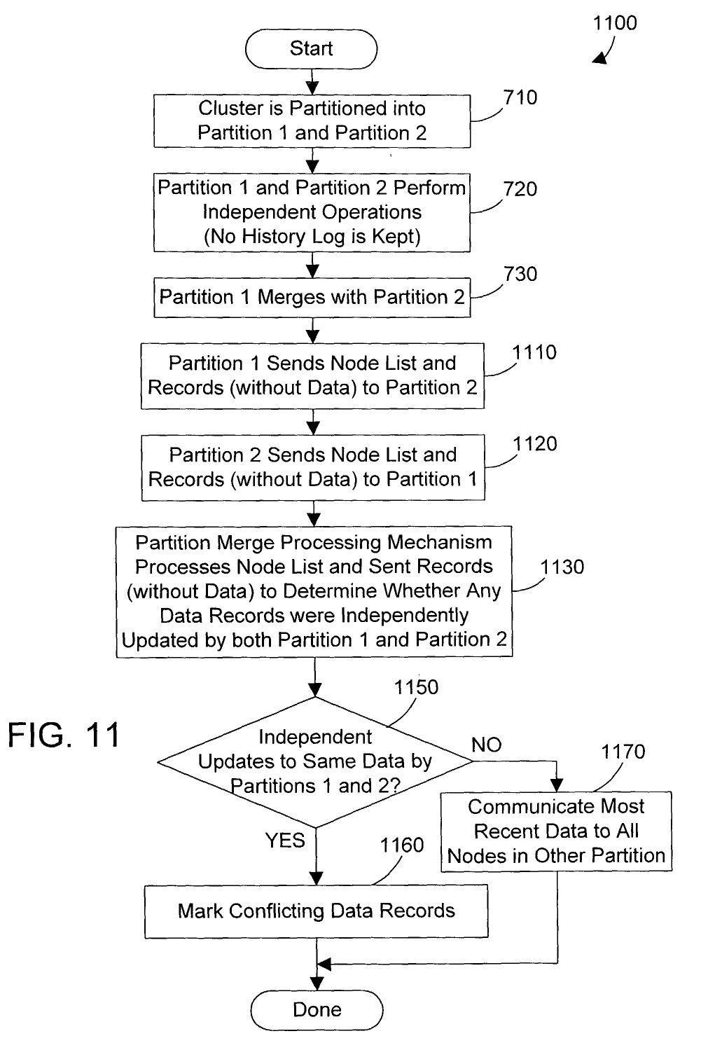

A sample method within the scope of the preferred embodiments is shown in the flow diagram of FIG. 11. We assume that a cluster is partitioned, arbitrarily labeled here Partition 1 and Partition 2 (step 710). We also assume that Partition 1 and Partition 2 perform independent operations while the partition exists (step 720). Next, Partition 1 merges with Partition 2 (step 730). At this point, Partition 1 sends a node list and data record headers (i.e., data records without their corresponding data) to Partition 2 (step 1110). In similar fashion, Partition 2 sends a node list and data record headers to Partition 1 (step 1120). The partition merge processing mechanism now processes the node list and the record headers sent in steps 1110 and 1120 and compares the record header information to local data records to determine from the view value and leave view value whether sent records or local records are the most recent (step 1130). Note that it is possible for both partitions to update the same data record while partitioned, resulting in inconsistent data between the two partitions. If there were independent updates to the same data by both partitions (step 1150=YES), the conflicting data records are marked (step 1160). An application that uses the conflicting data may then take appropriate action, such as aborting or resetting the transaction(s) that caused the independent updates. If there were no independent updates to the same data by both partitions (step 1150=NO), the most recent data discovered in step 1130 is then communicated to all nodes in the other partition (step 1170) to assure that all nodes in the other partition have the most recent data.

A need to reconcile potentially conflicting data records in different nodes in a cluster can only occur when a partition is merging back together. On merging together, each partition selects a leader. Each leader sends to nodes in the other partition its node list and all record headers (i.e., records without the corresponding data field). Only one node from each partition needs to send this information, since all nodes in a partition have the same information.

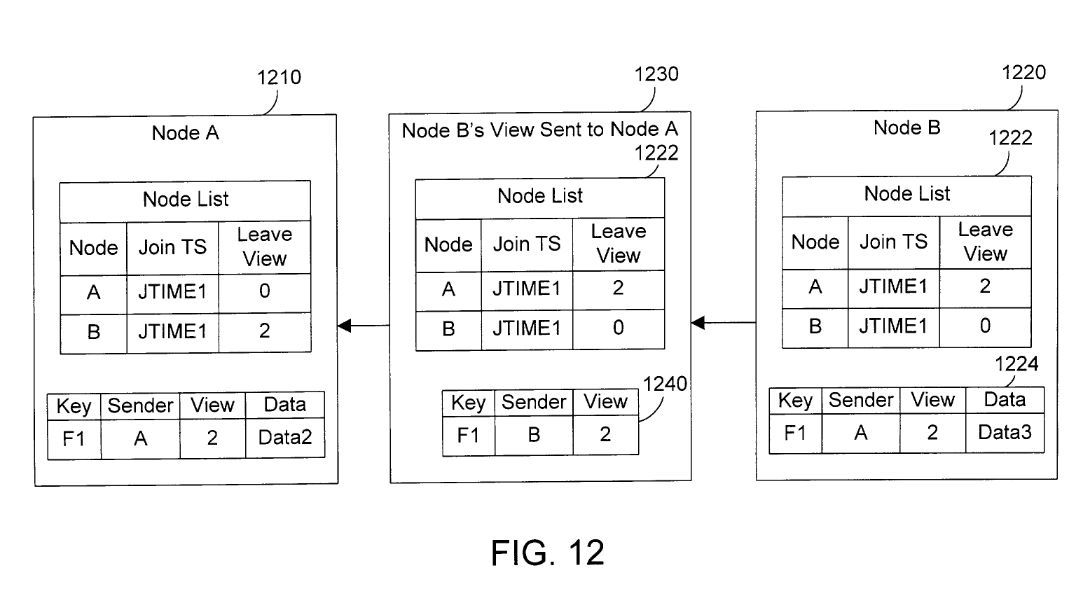

One suitable implementation for processing data records during a merge in accordance with the preferred embodiments is shown in FIGS. 12-15. FIG. 12 shows a specific example of step 1120 of FIG. 11, assuming that node A 1210 is in Partition 1 and node B 1220 is in Partition 2. In this example in FIG. 12, node B 1220 includes a node list 1222 and a data record 1224. The node list 1222 is sent to Node A 1210, shown in FIG. 12 as Node B's view sent to Node A 1230. Note, however, that Node B does not send the entire data record 1224 to Node A. Instead, Node B 1220 sends the data record without its corresponding data, which is represented as record header 1240 in FIG. 12. Note also that the Sender field is changed from A to B in the record header 1240 because node B is the sender of the record header 1240.

A detailed flow diagram is shown in FIGS. 13-15 as one suitable example of a specific implementation for steps 1130, 1150, 1160, and 1170 in FIG. 11. During the merge in step 730, one node in each of the previous partitions sends the node list and data record headers (i.e., data records without their corresponding data) to all the nodes in the other partition. Now the data records must be processed to determine which contain the most recent data. Method 1300 of FIGS. 13-15 represents the processing of a single record header, and is preferably repeated for each received record header. Again, note that the received record header does not contain the actual data. First, the key of the received record header is read (step 1310). Next, the local records are searched to see if the key exists in the local records. As stated above, we assume the key value of a record is unique in a cluster. Thus, if a local record exists that has the same key value as the received record header, we know that the local record and record corresponding to the received record header represent the same data record. If there is no local record that has the same key as the received record header (step 1320=NO), the sent record (including data) is sent to all nodes in the partition that include the local node (step 1330). If there is a local record with the same key as the received record header (step 1320=YES), we next check to see if the sender of the local record is the same as the sender of the received record header (step 1340).

If the sender of the local record is not the same as the sender of the received record header (step 1340=NO), we go to box 1350 to perform certain functions. In box 1350, if the local record view is greater than or equal to the leave view of the sender, this means the local node changed the local record when the sender was not in the same partition as the local node. If the send record view is greater than or equal to the leave view of the local node, this means the sender changed the record when the sender was not in the same partition as the local node. If condition (1) is satisfied and condition (2) is not satisfied, the most current data is present on the local node, and this data record (including corresponding data) is sent to all nodes in the partition that included the Sender. If condition (1) is not satisfied and condition (2) is satisfied, the most recent data resides on the sender, and the data record (including corresponding data) is sent from the sender to all nodes in the partition that included the local node. If both conditions (1) and (2) are satisfied, this means that the local record conflicts with the sent record, which means that both partitions updated this data during the partition. Because the data is in conflict, both the local record and the sent record are marked as in conflict. An application may act on the indication of conflicting data in a suitable manner, such as aborting one or more transactions that generated the conflicting data. For example, in the specific case of a web site performing online commerce, if such conflicting data is found, the web server application may simply indicate to the user that an error was encountered, and require that the order data be re-entered by the user.

In step 1340, if the sender of the local record is the same as the sender of the received record header (step 1340=YES), we must now compare the join timestamp (JTS) for the sender in the local node list with the JTS for the sender in the sent node list. The use of the join timestamp is to remove the possibility that the same sender's cluster node could have ended and restarted while partitioned. Since each partition keeps its own view until the merge (i.e., the merge membership change message will have a view that is at least one larger than the largest view in any partition), it is possible that both partitions have the same record view. By checking the join timestamp, it is assured that only the most recent time the sender joined the cluster will be used.

If the join timestamps are equal (step 1360=YES), we go to box 1410 in FIG. 14. If the sent record view is greater than the local record view, the sent record view is the most recent, and the sent record (including data) is sent to all nodes in the partition that included the local node. If the local record view is greater than the sent record view, the local record is the most recent, and the local record (including data) is sent to all nodes in the partition that included the Sender. Note that the case of the local record view equaling the sent record view is an unlikely case, because the condition for arriving at box 1410 is that the join timestamps are equal in step 1360 of FIG. 13. If the system is working properly, under normal operating conditions, it is highly unlikely the local record view can equal the send record view when the join timestamps are equal. For this reason, the equal case is not represented in box 1410. Of course, in a particular implementation of box 1410, one could cause the equal case to indicate a conflict in data, because the odds of this happening are very low.

If the join timestamp for the sender in the local node list is not equal to the join timestamp of the sender in the sent node list (step 1360=NO), we go to box 1510 of FIG. 15. If the join timestamp JTS for the sender in the local node list is greater than the join timestamp for the sender in the sent node list, the local record is more recent than the sent record, and the local record (including data) is sent to all nodes in the partition that included the Sender. If the join timestamp for the sender in the sent node list is greater than the join timestamp for the sender in the local node list, the sent record is more recent than the local record, so the sent record (including data) is sent to all nodes in the partition that included the local node.

In many applications for computer clusters, the assumption is that the same client usually updates the same data records. This is the case in many applications, such as web servers or e-commerce, such as IBM Websphere. For example, if a user requests pages from a web server, the server keeps data about the user's connection that it shares with other servers. If the server the user is connected to goes down or changes for load balancing reasons, an alternate server can take over. However, no other client other than the user can update the data that pertains to the user. Other applications such as online ordering, queries, etc. are similar in that there is a set of data that is to be shared across multiple nodes that is mostly associated with a particular client.

The preferred embodiments provides a simple way to reconcile potentially conflicting data during a merge in a computer cluster. Instead of storing each data record in a history log with a timestamp derived from a synchronized real-time clock, a view field is provided in each data record that provides an indication of relative time based on membership changes to the cluster. In addition, only the header information of the data records need be examined to determine which record is more recent, alleviating the cluster of the network bandwidth that would be consumed if the actual data were transmitted. The result is a simple yet effective way to reconcile potential data conflicts during a merge in a computer cluster.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

We claim:

1. An apparatus comprising:
at least one processor;
a memory coupled to the at least one processor;
a cluster engine residing in the memory and executed by the at least one processor;
a logical clock residing in the memory that in incremented each time the cluster engine receives a membership change message; and
at least one data record residing in the memory, each data record including a value of the logical clock when the data record is created or changed.

2. The apparatus of claim 1 further comprising a partition merge processing mechanism that processes the at least one data record during a merge occurs between a first partition that includes the apparatus and second partition in a computer cluster, and that determines which of the at least one data record contains valid data from the value of the logical clock in the at least one data record.

3. The apparatus of claim 2 wherein the partition merge processing mechanism sends a first node list to at least one computer that was in the second partition and sends a first set of data records without their respective data portions to at least one computer that was in the second partition.

4. The apparatus of claim 2 wherein the partition merge processing mechanism receives a second node list from at least one computer that was in the second partition and receives a second set of data records without their respective data portions from at least one computer that was in the second partition.

5. The apparatus of claim 2 wherein the partition merge processing mechanism processes the first and second sets of data records without their respective data to determine which of the data records contains valid data during the merge.

6. The apparatus of claim 2 wherein the partition merge processing mechanism marks a plurality of data records as conflicting if the plurality of data records were updated independently in the first and second partitions while partitioned.

7. A networked computer system comprising:
a cluster of computer systems that each includes:
a network interface that couples each computer system via a network to other computer systems in the cluster;
a memory;
a cluster engine residing in the memory and executed by the at least one processor; and
a partition merge processing mechanism that detects when a first partition in the cluster merges with a second partition in the cluster, and in response to the merge, determines which of a plurality of data records contain valid data from a logical clock value stored in each of the plurality of data records, the logical clock value being derived from a logical clock that is incremented each time a membership change message in the cluster is received by the cluster engine.

8. The networked computer system of claim 7 wherein the partition merge processing mechanism sends a first node list to at least one computer that was in a different partition and sends a first set of data records without their respective data portions to at least one computer that was in the different partition.

9. The networked computer system of claim 7 wherein the partition merge processing mechanism receives a second node list from at least one computer that was in the different partition and receives a second set of data records without their respective data portions from at least one computer that was in the different partition.

10. The networked computer system of claim 7 wherein the partition merge processing mechanism processes the first and second sets of data records without their respective data to determine which of the data records contains valid data during the merge.

11. The networked computer system of claim 7 wherein the partition merge processing mechanism marks a plurality of data records as conflicting if the plurality of data records were updated independently in the first and second partitions while partitioned.

12. A computer-implemented method for storing a plurality of data records in a computer cluster in a manner that allows easily determining which of the plurality of data records in a computer cluster are valid during a merge between a first and second partition in the cluster, the method comprising the steps of:
(A) providing a logical clock that is incremented with each membership change to the cluster; and
(B) storing the value of the logical clock as part of each data record when the data record is created or changed.

13. The method of claim 12 further comprising the step of:
(C) processing the plurality of data records during the merge to determine from the logical clock values stored in the plurality of data records which of the data records contain valid data during the merge.

14. The method of claim 12 further comprising the step of copying the data records that are valid to all computers in the cluster.

15. The method of claim 12 wherein step (C) comprises the steps of:
sending a first node list from a computer system in the first partition to a computer system in the second partition; and
sending a first set of data records without their respective data portions from a computer system in the first partition to a computer system in the second partition.

16. The method of claim 15 wherein step (C) further comprises the steps of:
sending a second node list from a computer system in the second partition to a computer system in the first partition; and
sending a second set of data records without their respective data portions from a computer system in the second partition to a computer system in the first partition.

17. The method of claim 16 wherein step (C) further comprises the step of:
processing the logical clock values in the first and second sets of data records without their respective data to determine which of the data records contains valid data during the merge.

18. A computer-implemented method for determining which of a plurality of data records in a computer cluster are valid during a merge between a first and second partition in the cluster, the method comprising the steps of:
(A) providing a logical clock that is incremented with each membership change to the cluster;
(B) storing the value of the logical clock as part of each data record when the data record is created or changed; and
(C) processing the plurality of data records during the merge to determine from the logical clock values stored in the plurality of data records which of the data records contain valid data during the merge.

19. The method of claim 18 further comprising the step of copying the valid data to all computers in the cluster.

20. The method of claim 18 wherein step (C) comprises the steps of:
sending a first node list from a computer system in the first partition to a computer system in the second partition; and
sending a first set of data records without their respective data portions from a computer system in the first partition to a computer system in the second partition.

21. The method of claim 20 wherein step (C) further comprises the steps of:
sending a second node list from a computer system in the second partition to a computer system in the first partition; and
sending a second set of data records without their respective data portions from a computer system in the second partition to a computer system in the first partition.

22. The method of claim 21 wherein step (C) further comprises the step of:
processing the logical clock values in the first and second sets of data records without their respective data to determine which of the data records contains valid data during the merge.

23. A computer-implemented method for determining which of a plurality of data records in a computer cluster are valid during a merge between a first and second partition in the cluster, the method comprising the steps of:
a first computer that was in the first partition sending a first node list to at least one computer that was in the second partition;
the first computer sending a first set of data records without their respective data portions to the at least one computer that was in the second partition;
a second computer that was in the second partition sending a second node list to at least one computer that was in the first partition;
the second computer sending a second set of data records without their respective data portions to the at least one computer that was in the first partition; and
processing the first and second sets of data records without their respective data to determine which of the data records contains valid data during the merge.

24. The method of claim 23 further comprising the step of copying the valid data to all computers in the cluster.

25. A program product comprising:
(A) a cluster engine that communicates with the other cluster engines in a computer cluster;
(B) a logical clock that is incremented with each membership change message received by the cluster engine;
(C) a data processing mechanism that creates a plurality of data records that each contain a value of the logical clock at the time the data record is created or changed; and
(D) computer-readable signal bearing media bearing the cluster engine, the logical clock, and the data processing mechanism.

26. The program product of claim 25 wherein the signal bearing media comprises recordable media.

27. The program product of claim 25 wherein the signal bearing media comprises transmission media.

28. The program product of claim 25 further comprising a partition merge processing mechanism that processes the at least one data record during a merge occurs between a first partition and second partition in a computer cluster, and that determines which of the plurality of data records contain valid data from the value of the logical clock in the plurality of data records.

29. The program product of claim 28 wherein the partition merge processing mechanism sends a first node list to at least one computer that was in the second partition and sends a first set of data records without their respective data portions to at least one computer that was in the second partition.

30. The program product of claim 28 wherein the partition merge processing mechanism receives a second node list from at least one computer that was in the second partition and receives a second set of data records without their respective data portions from at least one computer that was in the second partition.

31. The program product of claim 28 wherein the partition merge processing mechanism processes the first and second sets of data records without their respective data to determine which of the data records contains valid data during the merge.

32. The program product of claim 28 wherein the partition merge processing mechanism marks a plurality of data records as conflicting if the plurality of data records were updated independently in the first and second partitions while partitioned.

33. A program product comprising:
(A) a partition merge processing mechanism that detects when a first partition in a computer cluster merges with a second partition in the cluster, and in response to the merge, determines which of a plurality of data records contain valid data from a logical clock value stored in each of the plurality of data records, the logical clock value being derived from a logical clock that is incremented each time a membership change occurs in the cluster; and
(B) computer-readable signal bearing media bearing the partition merge processing mechanism.

34. The program product of claim 33 wherein the signal bearing media comprises recordable media.

35. The program product of claim 33 wherein the signal bearing media comprises transmission media.
